(19) United States
(12) Patent Application Publication
(10) Pub. No.: US 2006/0226169 A1
(43) Pub. Date: Oct. 12, 2006

(54) Lid dispenser

(76) Inventors: Megan Davis, Palm City, FL (US); Michael Garbutt, Durham, NC (US)

Correspondence Address: KEVIN REDMOND, 6969 SW GATOR TRAIL, PALM CITY, FL, 34990, US

(21) Appl. No.: 11/401,059

(22) Filed: Apr. 10, 2006

Related U.S. Application Data
(60) Provisional application No. 60/669,932, filed on Apr. 11, 2005.

(51) Int. Cl. B65G 59/04

(52) U.S. Cl. 221/211

(57) ABSTRACT

Apparatus for dispensing lids and other articles such as plates, condiments, etc. comprising a threaded shaft powered by an electric motor which is used to raise a stack of items from the bottom of a storage hopper. A vacuum system, in a first embodiment comprised of a fan and a sliding tube, lifts the top most item from the stack, making it available to a user. A sensor at the top of the dispenser is used to detect the absence of an item in the dispensing position and again raises the stack of items, placing the top most item in position to be raised up by the vacuum system and again made ready for pick up by the user.

### BACKGROUND

1. Field

The present invention relates to dispensers for articles and more particularly to dispensers for cup lids.

2. Prior Art

The prior art is described in the following summary of five prior art patents:

U.S. Pat. No. 4,319,441 illustrates an invention which performs multiple functions including lid dispensing that uses a carousel system wherein a cup is moved through several stations. However, this invention uses a circular translational motion to dispense lids which are stacked one above the other prior to being dispensed. This system uses gravity feed and removes the bottom most lid. The lids often have identical and at least partially interlocking configurations, causing them to stick together and jam as the dispenser attempts to dispense multiple lids simultaneously.

U.S. Pat. No. 4,949,526 illustrates an automatic lid dispenser. The lids are stacked in a hopper. At the bottom of the hopper is a lid shuttle with an engagement mechanism. The mechanism attempts to grip the bottom most lid and place it in a rotatable supply carousel from which the lids are applied to cups. The gravity feed and translational movement of the bottom lid subject this device to the problems noted in connection with U.S. Pat. No. 4,319,441.

U.S. Pat. No. 5,322,188 illustrates an automatic lid dispenser. The lids are supported by two pairs of members. The upper members hold the lids in place while the lower members grips the two bottom most lids. The very bottom most lid falls unsupported while the remaining lids continues to be held by the members until another lid is dispensed. The grip must hold the entire stack of lids every time the bottom most lid is removed. When the grips wear, the mechanism fails because it attempts to dispense multiple lids at once.

U.S. Pat. No. 6,651,841 illustrates a machine used for dispensing articles. This machine uses a pair of mechanisms to lift a portion of the stack of articles during a sliding operation and returns the stack once the bottom article has been dispensed. This device also uses gravity feed and a translational mechanical device operating on the bottom most lid and is subject to all the potential failures noted above for such systems.

U.S. Pat. No. 6,755,325 illustrates an automatic dispensing system. This system uses a product chamber with a component that regulates the flow of dispensable items. A bladder with an air pump applies constant pressure to the dispensable products. This system first compresses the lids together with the bladder. There is a tendency for the lids to stick together with gravity feed alone. Adding the bladder pressure only increases the tendency to stick together. This system increases this risk of failure when the bladder pressure is applied to the lids.

The present invention overcomes the problems of gravity feed and lid compression found in the prior art.

### SUMMARY

An object of the present invention is to not use gravity feed nor compression of the lids in an automatic dispenser to avoid failure caused by the jamming of the lids.

An object of the present invention is to raise, separate and deliver lids by means of a vacuum system to avoid jamming encountered with prior art gravity feed systems.

The present invention in a first embodiment is an automatic system for dispensing cup lids. This system employs a threaded shaft which is connected to an electric motor that is used to lift the lids from the bottom of a storage hopper where the lids are stacked prior to being dispensed. In this system, the lids ride on a platform which is supported by a bracket. The threaded shaft is passed through a mating threaded hole in the bracket. When the shaft is rotated by the electric motor, the platform and the lids rise to a level where the top most lid in a stack is in a position where it may be picked up by a vacuum system and dispensed to a user. Vacuum is used to lift and dispense an individual lid to the user, reducing or eliminating human contact with the lids before they are received by the user, thereby improving the cleanliness of the dispensing operation. In a second improved embodiment, a pick up system along with a delivery chute is added to the first embodiment to provide a more positive lid delivery system.

### BRIEF DESCRIPTION OF THE FIGURES

FIG. 1 is a front perspective view of the lid dispenser.

FIG. 2 is a front perspective view of the lid dispenser with a hopper opened to enable the hopper to be replenished with lids.

FIG. 3 is a front perspective view of the upper portion of the lid dispenser with the front cover removed to reveal the operating components.

FIG. 4 is a rear perspective view of the lower section of the dispenser with the rear panel removed to reveal the operating components.

FIG. 5 is a block diagram of the central control system for the lid dispenser. This diagram shows the interconnection of the sensors, motor, fan and lid ejector.

FIG. 6 is a perspective front view of the upper suction assembly of the second embodiment.

FIG. 7 is a perspective front view of the upper section assembly of the second embodiment with a lid being carried by the suction tube.

FIG. 8 is a perspective view of a mechanism for moving lids from the hopper to the delivery chute in the second embodiment with a lid to be moved still in the hopper.

FIG. 9 is a perspective view of the mechanism for moving lids from the hopper to the delivery chute with the lid to be moved now in the chute.

FIG. 10 is the upper section tube positioned above the delivery chute carrying the lid to be moved.

FIG. 11 is the upper suction tube positioned in the delivery chute holding the lid to be moved.

FIG. 12 is the upper suction tube positioned after releasing the lid into the delivery chute.

FIG. 13 is a perspective view of the lower hopper mechanism in the second embodiment.

FIG. 14 is a perspective view of the lower hopper mechanism in the second embodiment with the lid tray tilted outwardly of the hopper mechanism to accept a supply of lids.

FIG. 15 is similar to FIG. 15 only the side has been removed to show the lid platform.

FIG. 16 is a block diagram showing the organization and connections of the major components of the second embodiment to the electronic control unit.

FIG. 17 is a logic decision chart for the control system of the second embodiment.

FIG. 18 is a perspective outside front view of a complete unit of the second embodiment.

FIG. 19 is a perspective outside front view of a complete unit of the second embodiment showing a hopper tilted out from the unit to accept lids.

### DETAILED DESCRIPTION OF THE INVENTION

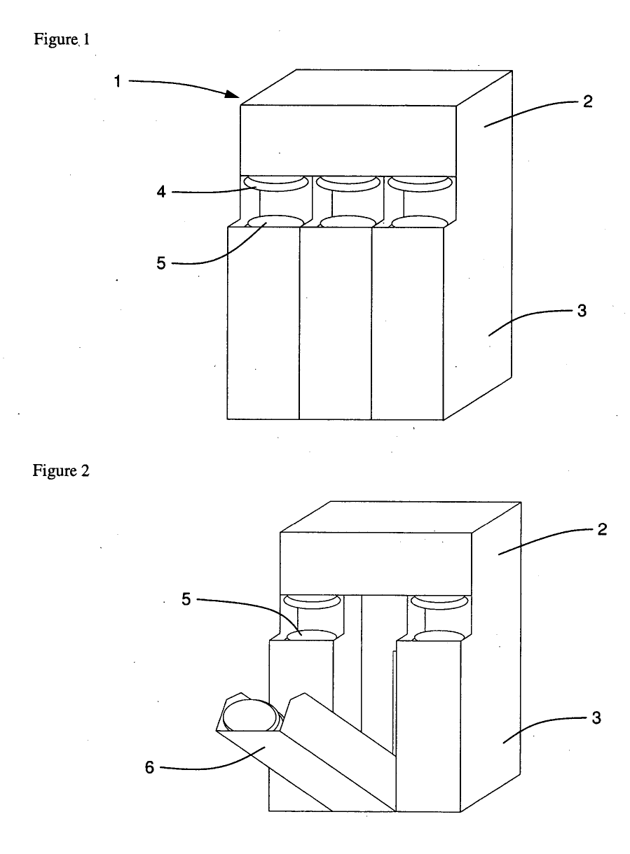

The first embodiment of this invention which describes the principal operating system is described in connection with FIG. 1-5.

FIG. 1 is a front perceptive view of the lid dispenser shows the dispenser unit 1, to include an upper assembly 2, a lower assembly 3, a lid 4 ready for being dispensed, and a stack of stored lids 5. In the operation of this unit, a lid on top of stack 5 is lifted up by vacuum above the stack where it can be accessed by a user.

FIG. 2 is a front perspective view of the lid dispenser shown in FIG. 1 with a hopper 6 tipped forward to enable the hopper to be replenished with lids. Three hoppers are shown side by side in this Figure to enable a single dispenser unit to accommodate three different sized lids.

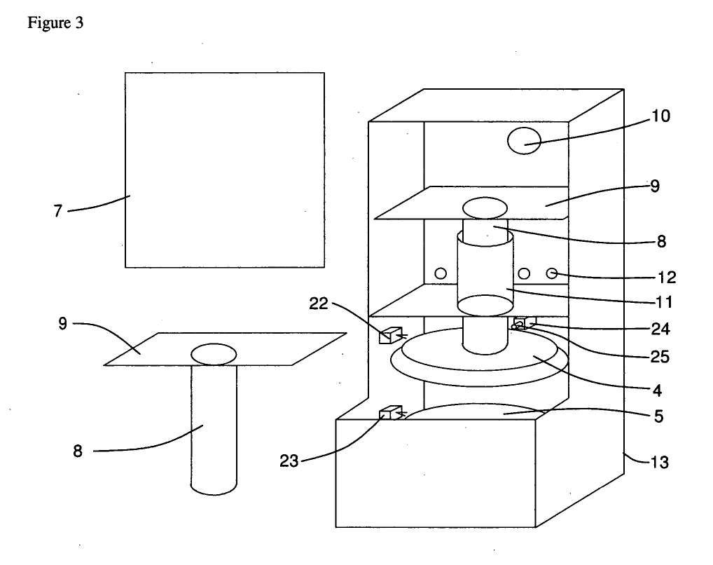

FIG. 3 is a front perspective view of the upper assembly of the lid dispenser with the front cover removed to reveal the operating components within the dispenser unit. In this view, the dispenser unit can be seen to include a dispenser lid sensor 22, a sliding tube 8, a sliding tube plate 9, a vacuum connection port 10, a guide 11 for the sliding tube 8, an air ventilation port 12, and a case 13.

In the operation of the upper assembly of the first embodiment of the invention which is shown in FIG. 3, a vacuum that is applied to port 10, is directed down through sliding tube 8 where it draws up the top lid from the stack of lids 5. Note that the sliding plate has an air tight seal to the case 13 and maintains this seal as this plate moves within the case. The plate and the tube can move downward to enable the sliding tube to be close to the stack and enable this tube to pick up the top lid. The vacuum from port 10 is applied only to the top lid as the sliding tube 8 is placed directly over this lid. The vacuum lifts the sliding tube plate 9, the sliding tube 8, and the top lid. Even if the lids are stuck together, the vacuum in tube 8 will tend to pull the top lid apart from the rest of the lids in the stack. It is this feature that distinguish the invention from the prior art discussed earlier. Once the lid has been raised from the stack of lids 5, it is easily accessible to a user as one portion of the lid extends out from the case and can be gripped by the user and removed.

The dispensed lid sensor 22 is located inside the upper assembly and is attached to the case walls 13. The purpose of sensor 22 is to detect the absence of a lid in the ready-to-be-dispensed position which is the position lid 4 is in, in FIG. 3 This sensor can take on anyone of several forms, such as mechanical or optical device as long as it provides a signal indicating the absence of a lid in the position of lid 4 as shown in this Figure.

This signal is fed to a central control unit 26 which is located in the lower assembly and provides an output when there is a lid in the ready-to-be-dispensed position, preventing the motor from operating, which results in leaving the stack of lids 5 in place. In one embodiment of the invention, this output signal may also be used to operate the lid ejector 24 which uses the lid ejector arm 25 to force the lid 4 out of the dispenser. By ejecting the lid, the vacuum is no longer needed to hold lid 4 and may be shut down, saving power, reducing noise level, and saving wear and tear on the equipment. The ejector may also take many forms, the simplest of which is a solenoid that actuates the arm 25 to eject a lid from the dispenser.

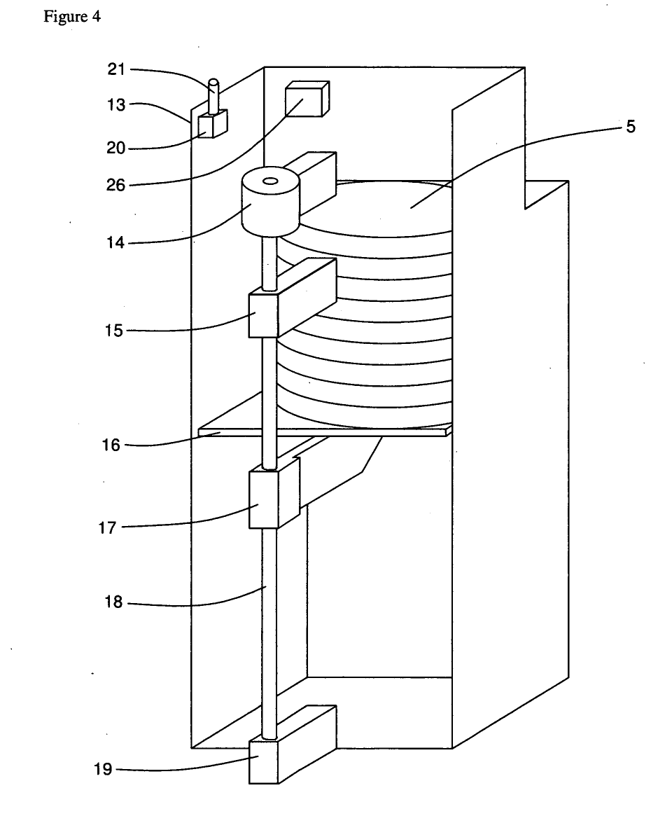

FIG. 4 is a rear perspective view of the lower section of the dispenser with the rear panel removed to reveal the operating components. This view shows the lower assembly to include the central controller 26, a fan 20, a vacuum hose 21 connected to the fan 20, an electric motor 14, a threaded shaft 18 connected to motor 14, a first bracket 15 and a second bracket 19 to align threaded shaft 18, a platform 16 to support and raise a stack of lids 5, a platform bracket 17 to support and move the platform 16, and two sensors, 86 and 87, to detect when the platform 16 reaches the top or bottom position on the threaded shaft 18. Platform bracket 17 is threaded on shaft 18, and is driven to move when motor 14 is activated. The back panel for the dispenser is simply a rectangular sheet which includes a vertical slot for bracket 17 which protrudes through the slot and travels with platform 16. The first and second bracket for aligning the threaded shaft 18 are attached to the back panel.

In the operation of the lower assembly, the stack of lids 5 rest on platform 16, which is supported by bracket 17. When the electric motor is activated, it turns the shaft 18 and drives the bracket 17 upwards. The motor is controlled to move the stack upward as lids are removed from the top of the stack by the vacuum system. This places the upper most lid in a position to be raised by the vacuum system of the upper assembly. The vacuum hose 21 is connected between the fan and port 10. When the fan is activated, it provides a vacuum at the vacuum connection port 10. As noted, this vacuum is then delivered through sliding tube 8 to pick up the top lid in the stack 5.

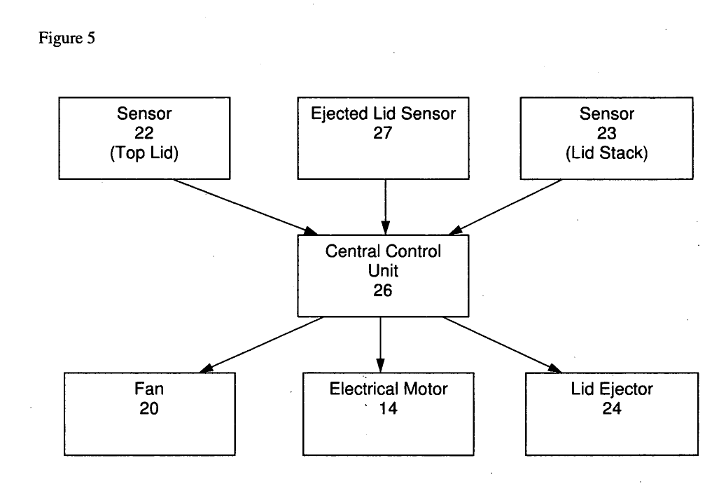

FIG. 5 is a block diagram of the central control system for the lid dispenser. This diagram shows the interconnection of the sensors, motor, fan, and a lid ejector. Wiring is not shown in the perspective views of the inside of the dispenser unit to avoid clutter.

There are a number of alternatives which fall within the spirit and scope of the invention. In one arrangement, the top most lid after having been picked up by the sliding tube may be ejected by a device such as a solenoid upon its detection as having been picked up. An ejected lid sensor sends a signal to the control unit to pick up another lid. In a second arrangement, the lid may be left attached to the suction tube by way of the sliding tube for pick up by a person using the dispenser. An improved system for the delivery of the lid is described in the second embodiment below.

It is obvious that the present invention is not limited to cup lids, but is applicable to a wide variety of articles including plates and packets of condiments.

### DETAILED DESCRIPTION OF THE SECOND EMBODIMENT

Note that drawings 6 through 19 refer to the second embodiment only.

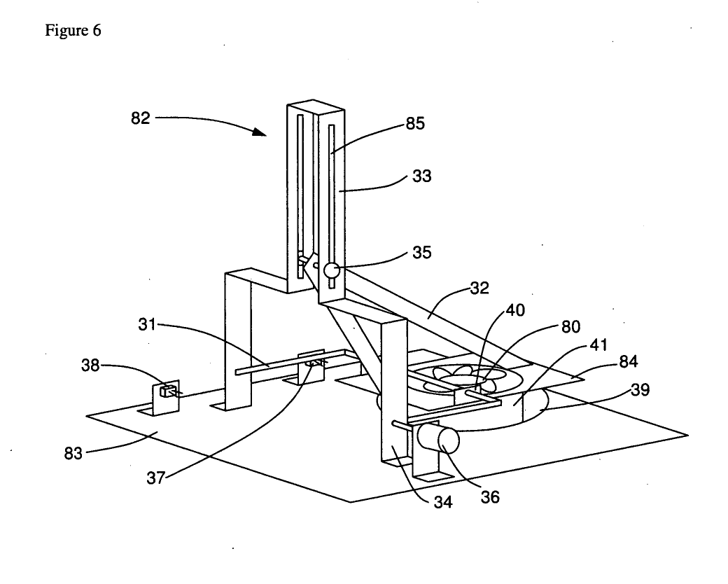

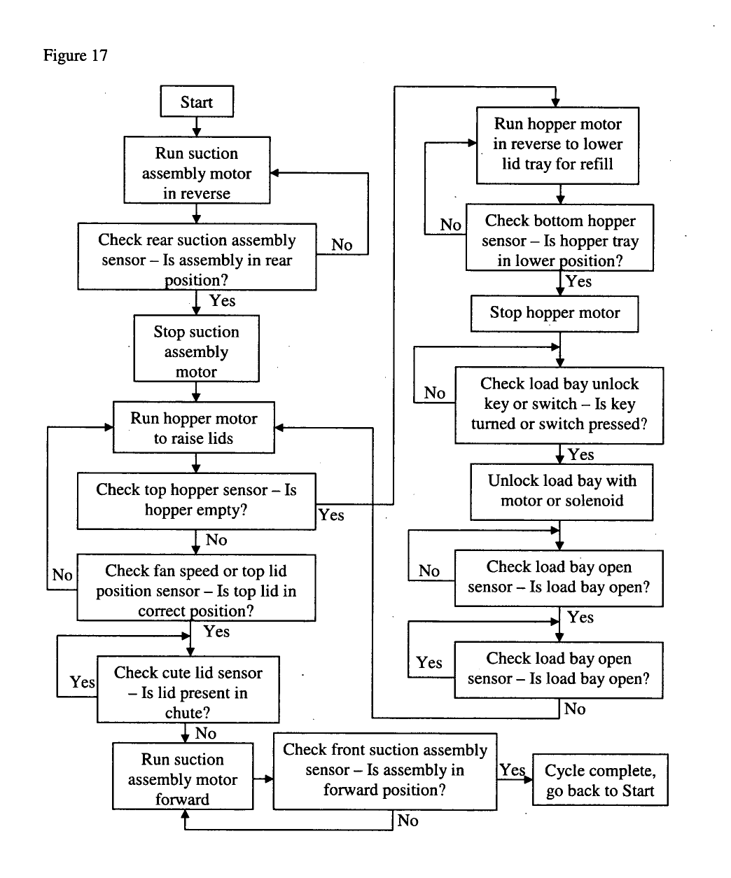

In the second embodiment of the present invention, several improvements over the first embodiment described above are made including:
(a) a lid pick-up and chute delivery system,
(b) means for vibrating the lids during pick-up is made to ensure separation of the lids
(c) the fan is mounted withing the tube to eliminate the requirement for ducting the suction to the tube as was done in the first embodiment
   The second embodiment is shown and described in FIG. 6 through 19.

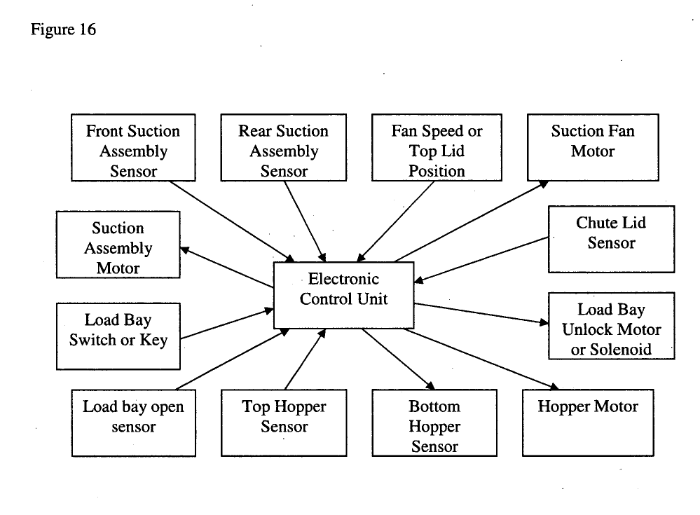

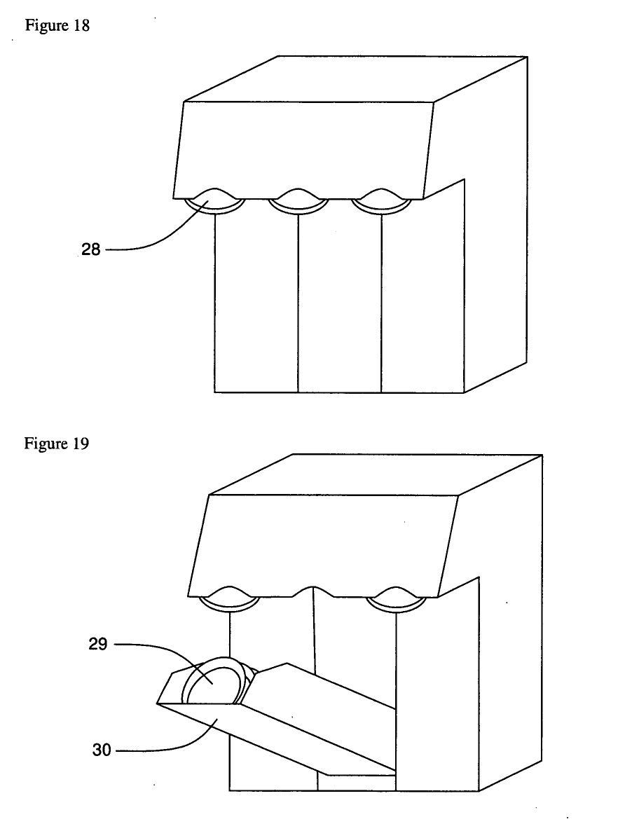

There are three main parts to the second embodiment of the dispenser, an upper suction assembly 75, a lower hopper 74 and a delivery mechanism 82. There may be multiples of the same part in one unit as shown in FIG. 18 where there are three dispensers 83, 84, and 85 side by side in one unit. Each dispenser can dispense a different sized lid if required. There is an Electronic Control Unit (ECU) 78 to control the operation of the dispenser. All sensor inputs are fed to the ECU and the ECU processes these signals by way of an internal program to transmit actuating signals to the various motors and solenoids which actuate the system. Wiring is not shown in the drawings to avoid clutter. Such wiring is well known in the art and does not require further elaboration here. A block diagram showing the interconnection between the various units and the ECU is shown in FIG. 16.

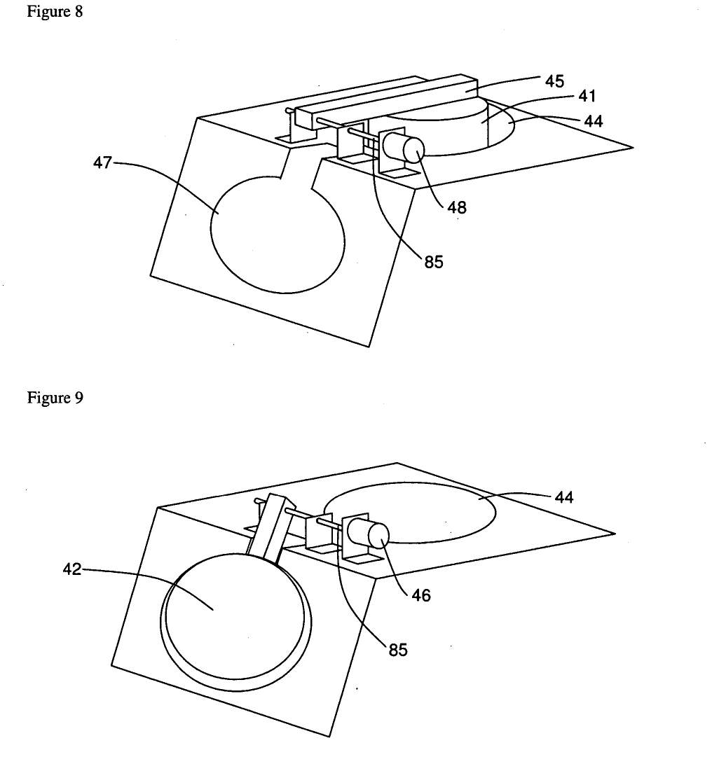

The upper delivery mechanism 82 shown in FIG. 8 is used to take lids from the top of a stack of lids and deliver them, one at a time, to an output chute which places the lids in a convenient position for pick up by a customer. The delivery mechanism 82 can be seen in FIG. 8 to comprise guide rails 33, a link pin 35, a bracket 33, a suction tube 41, a delivery mechanism mounting plate 83, an opening in the mounting plate 39, a first sensor 37 attached to mounting plate 83, a second electric motor 36 attached to plate 83, a bracket 34 mounted to plate 83 which is used to support guide rails 33, a forth sensor 37 mounted to plate 83, and a fan 80 mounted within suction tube 41. A rod 31 is attached to the second motor 36 and rotatively passes through brackets 34 and 37.

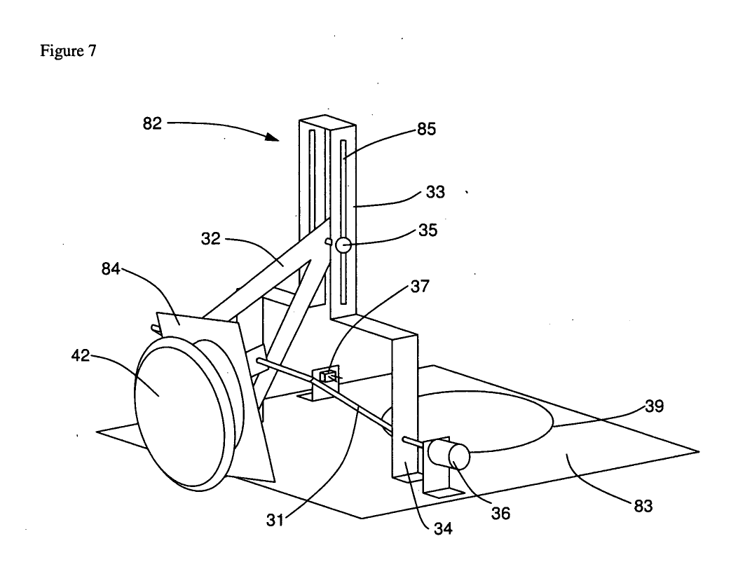

The operation of the delivery mechanism 82 can best be described with reference to both FIGS. 6 and 7. FIG. 6 shows the suction tube 41 supported by frame structure 32 which has two legs joined together at one end and attached to the flange 39 about the top of the suction tube 41 at two different points, each point being at an end of the legs away from where they are joined. The junction point of the two legs of frame 32 includes a hole which accepts a pin 35 that slides up and down within a slot 85 in the guard rails, constraining the junction end of the frame 32 to move with pin 35 in the slot in the guard rails.

As shown in FIG. 6, the fan 80, which is mounted inside the suction tube 41, produces a suction on the bottom of the suction tube by generating an up-draft in the suction tube.

This suction draws the top lid from a stack of lids located below the delivery mechanism. The top lid of the stack protrudes through the hole 39 in the plate 83 which positions this lid immediately below the bottom of the suction tube 41. When the fan is on, the suction created in tube 41 draws the top lid to the bottom of tube 41 and holds it there until the fan is shut off.

The rod 31 has the form of a crank shaft and is first rotated in a counter clockwise direction by the motor 36 on command from the ECU, causing the frame 32 and the suction tube to raised up and the suction tube to be transferred to the left side of the delivery mechanism as shown in FIG. 7, coming to rest with the bottom of the suction tube and the lid in a generally upright position.

An alternative delivery system is shown in FIGS. 8 and 9. The suction tube 41 is supported by a bar 45 which is connected to a drive shaft 85 that is driven by a third motor 48. The motor rotates the shaft 85 causing the bar 45 and the suction tube 41 along with a lid 42 to be rotated in a counter clock wise manner to a position near the front of the dispenser where it can be accepted by a customer. It produces the same general results as the delivery mechanism 82 described above.

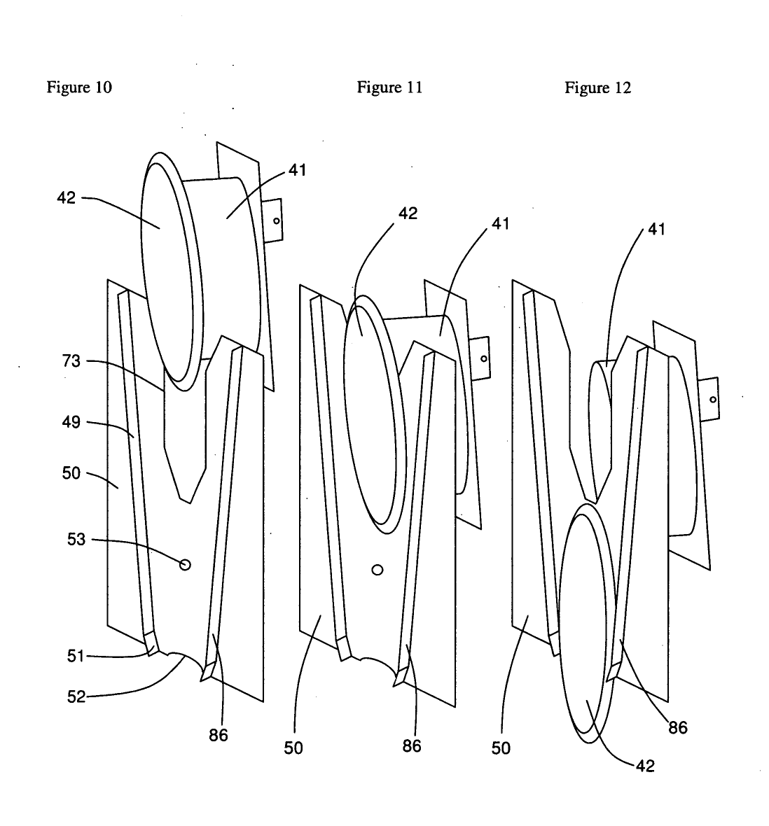

Both the delivery system 82 shown in FIG. 7 and the alternative delivery system of FIG. 8 take by means of the suction tube the top most lid from the stack of lids and deliver that lid to the front of the dispenser. However, additional equipment is necessary to position that lid where it can be easily accessed by a customer. That equipment is the chute shown in FIGS. 10, 11, and 12. These Figures are all of the same chute, but show the progression of the lid down the shoot in three steps.

The components shown in these Figures include the suction tube 41, the top most lid 42, which has been picked up by the suction tube and is now held to the bottom of this tube by suction, a chute mounting plate 50, a vertical slot 73 in the top of the chute plate 50, two sides of the chute 49 and 86 which are attached to and stand generally orthogonally to the plate 50, a sixth sensor 53 located in the lower portion of the plate 50 between the two sides of the chute to detect the presence of a lid in the chute, a narrowing of the distance between the chute sides at the bottom of the chute at drawing numeral 51 which is used to prevent a lid 42 from dropping out of the chute before it is withdrawn by a customer, and a cutout 52 in the lower portion of the plate 50 between the sides of the chute to facilitate the gripping of a lid by a customer.

In the operation of the chute, the lid 42 is delivered by the delivery mechanism to the slot 73 as shown in FIG. 10. The suction tube 41 is narrower than slot 73 and can fit into this slot; however, the diameter of lid 42 is greater than the width of the slot and must remain forward of the slot which is to the left of the slot in FIG. 10. As the suction tube continues rotating counter clockwise, the lid 41 moves further down the slot as shown in FIG. 11, eventually reaching the bottom of the slot as shown in FIG. 12, where the slot narrows and separates the lid from the suction tube. The tube's rotation also causes it to be pulled back from the chute near the end of its counter clockwise movement, further causing the lid to separate from the tube. The lid drops by means of gravity to the bottom of the chute where it is held by the narrowing sides of the chute at 51 until it is withdrawn by a customer. The sensor 53 detect the absence of a lid after withdrawal by a customer and transmits this information to the ECU where the ECU causes the delivery mechanism to deliver another lid to the chute and starts the cycle all over again.

The plate 5 is shown to be at an angle of approximately 80 degrees with the horizontal in FIGS. 10-12. This angle tends to cause the lid to be separated from the suction tube as it progresses down the chute and it also allows the bottom of the suction tube to disengage the slot 72 as it moves downward. The chute plate may be held at other angles or the plate may be rounded to achieve the same objectives.

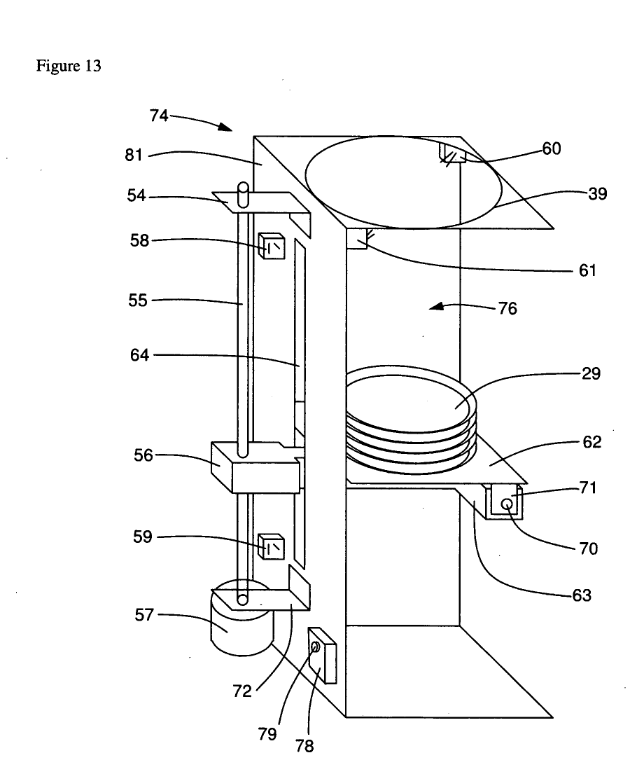

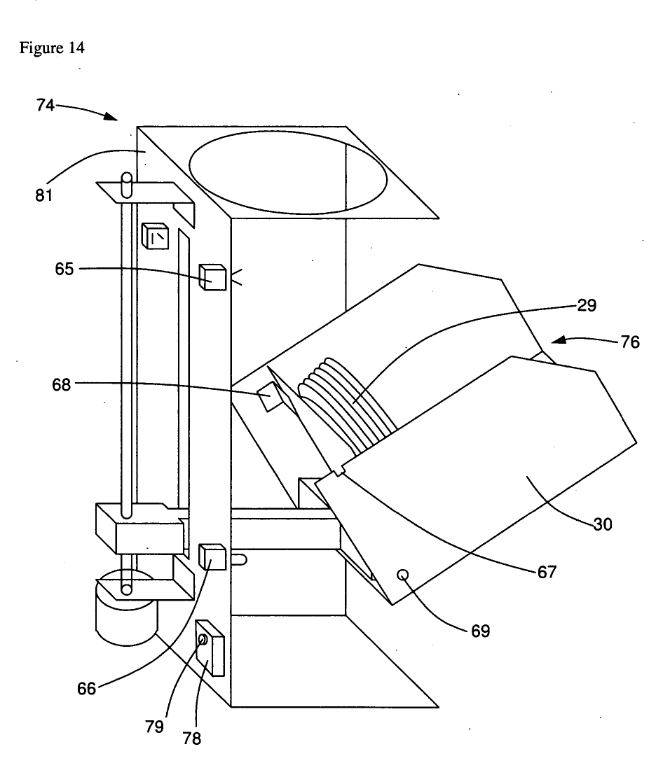

In the second embodiment, the lids are stacked and lifted up to where the top most lid may be picked up by the suction tube in a manner similar to that described in the first embodiment. As can be seen in FIG. 13, the lower hopper 74 of the Second Embodiment (SE) comprises a SE frame 81, a first SE bracket 54 attached to the frame and supporting the upper end of a SE threaded rod 55, a SE second sensor 58, a SE slot 64 in the frame of the lower hopper, a SE second bracket 56 with threads that mates with and ride on the thread of the threaded rod 55, a SE fifth sensor 59 mounted to the frame 81, a SE first electric motor 57 mounted to frame 81 and connected to the bottom of threaded shaft 55 to turn shaft 55 on command from the ECU to drive bracket 56 to a desired height, a SE second bracket 72 to support the lower end of threaded rod 55, a SE movable tray 62 connected by a series of brackets to and which moves with the bracket 56 that in turn rides on the threaded rod 55, a third bracket 63 connected to bracket 56 lies under and supports tray 62, a SE third bracket 71 connected to the bottom of and extending beneath tray 62 connects the tray to a hinge 70 which rotatable connects the bracket 71 to the bracket 63 allowing the tray to pivot to the rear for refilling as shown in FIG. 14, a stack of lids 29. A first sensor consisting of elements 60 and 61, a stack of lids 29 resting on the tray 62, in a cavity 76 within the hopper frame 81, a forth sensor consisting of elements 60 and 61, and an opening 39 it the top of the lower hopper frame 81

The above described elements work together to place the lids in position to be picked up by the suction tube 41. As can be seen in FIGS. 14,15 and 16 the lower hopper 74 contains the lids 29 to be dispensed. These lids are stored on tray 62 in cavity 76 in the lower hopper. The tray is raised and lowered mechanically by means of a screw threaded linear actuator. The actuator uses a first electric motor 57 to turn the threaded rod 55 held in place by brackets 54 and 72 mounted to the frame 81 of the lower hopper. The tray 62 is attached to a bracket 63 which passes through a slot 64 in the wall of the hopper frame 81 and is threaded onto the threaded rod 55. Then the motor 57 turns the threaded rod 55 and the bracket attached to the tray moves up or down with the turning of the threaded rod.

When in use dispensing lids, the tray is caused to be raised by the ECU 78 located at the base of the hopper whenever a lid is not detected at the top of the hopper by the first sensor which is located at the top of the hopper. This action, commanded by the ECU 78, moves the top lid upwards and into position below the upper suction assembly, as shown in FIG. 6, to enable the top lid to be removed from the stack.

The first sensor, as noted above, is made up of two elements 60 and 61 and detects when the top lid is in the correct position so that the motor 57 can be turned off. This is done by sending a signal from the sensor to the ECU which in turn operates the motor, driving the threaded rod to position the tray and lids accordingly. The first sensor is typical of many position sensor and can take many forms, such as being comprised of a light source as shown in one element such as element 61 which directs a light onto a light detector in element 62. When the light beam is broken by the lids after being raised into position just below the suction tube, a signal is sent to the electronic control unit 78 located at the base of the hopper which stops the motor until a lid is withdrawn from the top of the stack by the suction tube. Other detection systems, whether they be electric, mechanical or pneumatic. which accomplish the same task are considered equivalents.

A second sensor 58 detects when the tray reaches the end of its possible upward movement, and transmits this information to the electronic control unit, indicating that the hopper is empty. When the hopper is empty, or when the operator presses a switch 79 (shown in FIG. 13 on the ECU) to load the hopper, the tray within the hopper as controlled by the electronic control unit (ECU) 78 is lowered by reversing the motor 57. A second sensor 58 detects when the tray reaches the end of its possible downward movement and again stops the motor by way of a command from the ECU.

A solenoid 66 or equivalent device is used to unlock a load bay 30 which forms the front cover of the hopper and a third sensor 65 detects when the hopper has been opened. The operator can then open the cover and load the hopper with more lids as shown in FIG. 14 and FIG. 19. As an alternative equivalent the hopper may be opened and loaded from the back, allowing multiple stacks of lids to be pre-loaded.

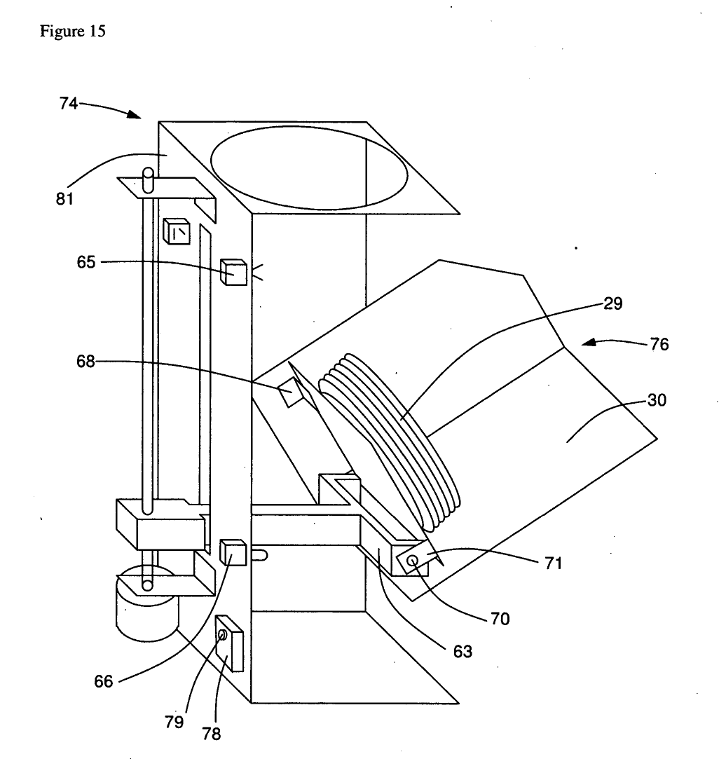

When the load bay 30 is opened by tilting it forward on a hinge 69 as shown in FIGS. 14 and 15, the tray 62 at the bottom of the hopper is also tilted on a hinge 70. The hinge on the tray is coaxially aligned with the hinge on the load bay and the bottom surface of the load bay includes a projection 68 to maintain the alignment of the tray with the load bay. This allows the operator to drop a complete stack of lids into the load bay without the bottom lid sliding under the tray. The operator can slide a complete stack of lids directly from the bag in which they are shipped into the load bay without touching any lids, for greater hygiene.

A third sensor 65 shown in FIG. 14, detects when the load bay is closed. A latching device such as a solenoid 66 or an alternate equivalent is used to lock the load bay. This sounds a signal to the ECU. Then the first motor 57 is turned on by the ECU to raise the lids into position for the upper suction assembly.

Different sized load bays and lid trays can be made interchangeable to accommodate different lid sizes.

The upper suction assembly is shown in FIGS. 6 and 7. A suction device, such as an electric fan or blower, draws air through a tube 41. The fan or blower is mounted within the tube and is not shown in the diagrams. The suction tube 41 is positioned vertically above a stack of lids in lid dispenser 29 in the lower hopper. There is an opening 39 in the base of the upper suction assembly that allows a lid to pass through without obstruction. Air flowing up through the tube 41 sucks the topmost lid against the bottom of the tube. There is a grid to prevent debris from being sucked into the tube and interfering with the operation of the fan.

A hinged mechanism moves the tube, along with the lid 42 that is sucked against the bottom of the tube. This mechanism lifts the lid 42 above the rest of the stack of lids in lid dispenser 29 and moves the lid toward the front of the dispenser as shown in FIG. 7. It rotates the lid to a near vertical orientation and drops it into a delivery chute 50, shown in FIGS. 10, 11 and 12, from which a user can take the lid. The hinged mechanism then moves the suction tube back to the original position above the stack of lids in the lower hopper.

The hinged mechanism consists of a bracket 32 affixed to the suction tube 41. The upper end of this bracket is constrained to move vertically by a shaft 35 within guide rails 33. A rotating rod 31 passes through the guide rail mounting 34 and through brackets 40 on the suction tube. The rotating rod 31 is driven by a second electric motor 36 and causes the suction tube to rotate and swivel. As the suction tube begins its travel from the position shown in FIG. 6, it initially rises vertically and then starts to move toward the front of the dispenser. The top of the bracket 32 rises in the guide rails 33 as the rotating rod 31 pulls the suction tube forward. The angle between the bracket 32 and the suction tube 41 causes the suction tube to swivel from a vertical to a horizontal position as it is moved forward by the rotating rod 31. The lid 42 attached to the suction tube also changes orientation as it is attached to the suction tube.

When the suction tube reaches the forward position, the lid is oriented approximately vertical and is moving downward attached to the suction tube. The suction tube and lid continue their downward movement and start moving back towards the hopper as the rotating rod 31 continues its arc past 180 degrees of rotation. This down and backward movement is used to drop the lid into the delivery chute 50, as shown in FIGS. 10, 11 and 12.

The rotating rod 31 is driven by the second motor 36 with the forth and fifth sensors 31 and 38 at each end of its field of rotation. The electronic circuit (not shown) uses these sensors to stop the motor at each end of its travel. The second motor is 36 reversed rapidly several times while lifting the lid from the top of the stack, to cause a vibration that helps to separate any lids that may be stuck together.

The cables for the fan motor in the suction tube 41 are routed up the bracket 32 and attached to the guide rails 33 with a loop of flexible cable.

This invention minimizes the likelihood of dispensing multiple lids at the same time by taking lids from the top of the stack, instead of the bottom. The bottom lid of the stack is more likely to be stuck to an adjacent lid because of the pressure from the weight of the rest of the lids above.

Some lids have features, such as spouts, that make the top of the lid uneven and asymmetrical. The system is designed to correctly position and dispense lids that are placed upside down in the hopper. Reliability is improved by making the upper suction assembly attach to the bottom of the lids (bottom facing up) because the bottom surface of the lid is commonly more even than the top surface.

When the lids stored in dispenser 29 in the lower hopper are raised by the hopper tray 66, the end of the tube 41 is blocked as the lid is sucked onto the bottom of the tube. This condition causes a change in the fan speed and air flow. This change can be detected by the electronic circuit in order to determine that a lid has been sucked onto the bottom of the tube. This method can be used in addition to, or instead of, the optical position sensor 60 and 61 that detects whether a lid is correctly positioned at the top of the hopper. The lid, now positioned on the bottom of the suction tube, is ready to be moved to the delivery chute when a sixth sensor 53 detects that a person has taken the previous lid from the bottom of the chute.

The fan can be turned off by the electronic circuit to conserve power, reduce noise and vibration, and extend the operating life of the fan. The fan only needs to be turned on while raising the lid from the hopper and moving it forward. Once in the forward position above the delivery chute, the fan can be turned off. Turning off the fan above the delivery chute also allows the lid to drop off the suction tube into the chute more easily.

An alternative upper suction assembly is shown in FIGS. 8 and 9. This method uses a suction tube 44 that rotates in a simple arc by means of a bracket 45 and third electric motor 46. The lid 48 rotates overhead and is released it when the suction tube 44 passes through a hole 48 in the delivery chute that is smaller than the lid. It has the same overall affect as the method discussed but it has the advantage of allowing easier adjustment of the chute angle. The first method shown in FIG. 6 has the advantage that the lid does not move forward of the chute before dropping into the chute. Depending on the specific requirements, the dispenser will use one of the two methods.

To load the dispenser with items, the front of the lower hopper is flipped forward, exposing a channel in which a stack of lids can be placed. Once all the lids are in place, the operator closes the front of the lower hopper.

At this point the dispenser moves lids from the hopper to the delivery chute as needed. When a person takes the lid from the delivery chute, the movable suction tube will again drop down and pick up the next lid and place it in the delivery chute.

Having described our invention we claim:

1. A dispenser of stackable items each of said stackable items individually having an upper and a lower surface comprising:
(a) a tray for supporting the bottom of a stack of said stackable item wherein said items are stacked one above another in a single item wide column,
(b) means for producing a suction,
(c) means for positioning said means for producing a suction above the top most item in said stack in such proximity to the upper surface of said top most item that said top most item is lifted by said suction away from said stack of items and said top most item adheres to said means for producing suction, thereby separating said top most item from said stack to position it to be withdrawn from said stack.

2. A dispenser of stackable items as claimed in claim 1, further comprising
means for lifting said tray after one each stackable item has been removed from the top of said stack to place the next top most item in the stack in the position that the previous top most item was in before it was removed by said means for producing suction.

3. A dispenser of stackable items as claimed in claim 1, further comprising
(a) a chute having a top and a bottom two sides and a sliding surface between said sides, said sliding surface sloping from the top of said chute downward towards the bottom of said chute, said chute being capable of holding at least one of said stackable items between said sides,
(b) means for transferring said stackable item from said means for producing a suction when above said stack to a position above proximate said the chute to place said stackable item in a position to be deposited deposition in said chute.

4. A dispenser of stackable items as claimed in claim 3 wherein the sides of said chute have a top and bottom edge and are attached to the chute at their bottom edges said sides standing generally above and orthogonally with respect to said sliding surface and are sufficiently separated to accept one stackable item near the top of said chute and the sides of said chute being narrowed at the bottom of said chute to catch and hold one of said stackable items from falling off said chute when deposited in the top of said chute, said item being held at the bottom of said chute by said narrowed sides and being in a position at the bottom of said chute where said stackable item is sufficiently exposed to be withdrawn from said chute by a customer.

5. A dispenser of stackable items as claimed in claim 3 wherein said means for transferring said stackable items from said means for producing a suction when above said stack to above the top of said chute includes means for moving said means for producing a suction from above said stack of items to a position proximate above the top of said chute while said means for producing a suction is holding a stackable items and further include means for terminating said suction when said means for producing a suction is proximate said chute to release said stackable items onto said chute from said means for producing a suction.

6. A dispenser of stackable items as claimed in claim 1 wherein said means for producing a suction is a blower housed within a tube the suction being produced at a first end of said tube and said top most stackable item be sucked against and held by said first end of said tube.

7. A dispenser of stackable item as claimed in claim 5 wherein said means for terminating the suction further includes an electrical control unit and means for detecting the presence of one of said stackable items in a position proximate said chute, said means for detecting the presence of one of said stackable items in a position proximate said chute transmits a presence signal to said electronic control unit when a stackable item is detected at which time said electronic control unit terminates the power to said means for producing suction to cause the suction to be lost and said stackable item to be released from said means for producing a suction to said chute.

8. A dispenser of stackable items as claimed in claim 3, wherein said chute further includes a slot in said chute which extends from the top of said chute part way down said chute, said slot extending through the upper end of the chute to create an opening in the top of said chute, said opening being wider then said means for producing a suction and narrower than said stackable item, said means for producing a suction being placed within said slot at the upper end of said chute and said stackable item being placed above said chute by said means for transferring said stackable item, said stackable item being held by suction to said means for producing a suction, while said means for producing a suction is placed in said slot, said slot narrowing near its bottom and said means for producing a suction being moved down and away from said slot by said means for transferring causing said stackable item to be released from said means for producing a suction into said chute.
